(19) United States
(12) Patent Application Publication
(10) Pub. No.: US 2009/0076813 A1
(43) Pub. Date: Mar. 19, 2009

(54) METHOD FOR SPEECH RECOGNITION USING UNCERTAINTY INFORMATION FOR SUB-BANDS IN NOISE ENVIRONMENT AND APPARATUS THEREOF

(75) Inventors: Ho Young JUNG, Daejeon (KR); Byung Ok Kang, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/138,921

(22) Filed: Jun. 13, 2008

(30) Foreign Application Priority Data
Sep. 19, 2007 (KR) 10-2007-0095401

(51) Int. Cl. G10L 15/20; G10L 15/00

(52) U.S. Cl. 704/233; 704/E15.039; 704/E15.001

(57) ABSTRACT

According to a method and apparatus for speech recognition in noise environment of the present invention using uncertainty information for sub-band, uncertainty information of each sub-band is extracted from estimated clean speech using noise modeling, and helps to extract speech features that are robust to noise using the extracted uncertainty information as a weight with respect to each sub-band. Also, an acoustic model is converted according to each sub-band weight, and speech recognition is performed based on the converted acoustic model and the extracted speech features. As a result, while the noise modeling over time is not so accurate, noise influence resulted from sub-bands having high corruption can be reduced according to the uncertainty information of the corresponding sub-band, and speech recognition performance in complex noise environments can be improved.

### CROSS-REFERENCE TO RELATED APPLICATION

This application claims priority to and the benefit of Korean Patent Application No. 2007-95401, filed Sep. 19, 2007, the disclosure of which is incorporated herein by reference in its entirety.

### BACKGROUND

1. Field of the Invention

The present invention relates to a method for speech recognition using uncertainty information for sub-bands processing in noise environments and an apparatus thereof, and more particularly, to a method for speech recognition in which a degree of uncertainty of estimated clean speech obtained by noisy signal modeling is calculated for each sub-band, and the calculated results are used as a weight with respect to each sub-band to extract a feature vector that is less affected by noise, so that speech recognition performance in noise environments is improved, and an apparatus thereof.

This work was supported by the IT R&D program of MIC/IITA[2006-S-036-02, Development of large vocabulary/interactive distributed/embedded VUI for new growth engine industries].

2. Discussion of Related Art

In speech recognition performance, it is important to extract a feature vector from the speech signal. Currently, Mel-Frequency Cepstrum Coefficient (MFCC) is widely used for the speech feature vector that expresses features of a speech signal using Discrete Fourier Transform (DFT). When the speech signal is under a noise condition, the current feature extraction process cannot solve severe noise components. That is, when the speech feature vector is extracted, an action to prevent the background noise from affecting the extraction of the speech feature vector should be taken.

To minimize effects brought on by the noise, a conventional method is disclosed in which modeling a noisy signal in a silent interval is performed to extract a speech feature vector that is robust to noise. However, while the noise modeling has a good performance during the silent interval, the noise modeling is less effectively performed due to an influence of speech during an interval, in which speech is mixed with noise, so that noise components still remains in estimated clean speech even though the noise is compensated for.

Alternatively, a method is suggested in which the entire frequency band is divided into a plurality of sub-bands to extract sub-band feature vectors and weights are applied to the extracted sub-band feature vectors to obtain a final speech feature vector. However, since the frequency band is simply divided into the sub-bands to extract the feature vectors in the method and initial weights are used for entire utterance, when noise characteristics are instantaneously changed during an interval in which speech is uttered, the change is not updated in real time. Therefore, it is difficult to obtain estimated clean speech highly similar to the original speech.

### SUMMARY OF THE INVENTION

The present invention is directed to a method and an apparatus for speech recognition capable of improving speech recognition performance in noise environments that varies over time by extracting uncertainty information of estimation process for each sub-band from estimated clean speech obtained by noise modeling to extract speech features that are resistant to noise using the extracted results as a weight with respect to each sub-band.

One aspect of the present invention provides a method for speech recognition in noise environments using uncertainty information for sub-bands, comprising the steps of: estimating clean speech, in which noise is removed, from an input noisy speech signal, extracting uncertainty information of estimation process for each sub-band from the estimated clean speech and extracting speech features using the extracted uncertainty information as a sub-band weight; and converting an acoustic model according to the sub-band weight to perform speech recognition based on the converted acoustic model and the extracted speech features.

Another aspect of the present invention provides an apparatus for speech recognition in noise environments using uncertainty information for sub-bands comprising: a feature extraction module for estimating clean speech from an input noisy speech signal to extract uncertainty information of each sub-band from the estimated clean speech and using the extracted uncertainty information as a sub-band weight to extract speech features; and a speech recognition module for converting an acoustic model according to the sub-band weight and performing speech recognition based on the converted acoustic model and the extracted speech features.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 is a block diagram illustrating the configuration of a speech recognition apparatus according to an exemplary embodiment of the present invention; and

FIG. 2 is a flowchart illustrating a method for speech recognition according to an exemplary embodiment of the present invention.

### DETAILED DESCRIPTION OF EMBODIMENTS

The present invention will now be described more fully hereinafter with reference to the accompanying drawings, in which exemplary embodiments of the invention are shown. This invention may, however, be embodied in different forms and should not be construed as limited to the exemplary embodiments set forth herein.

In the present exemplary embodiment, speech in which the original speech is mixed with background noise is referred to as noisy speech, and original speech estimated from the noisy speech is referred to as estimated clean speech.

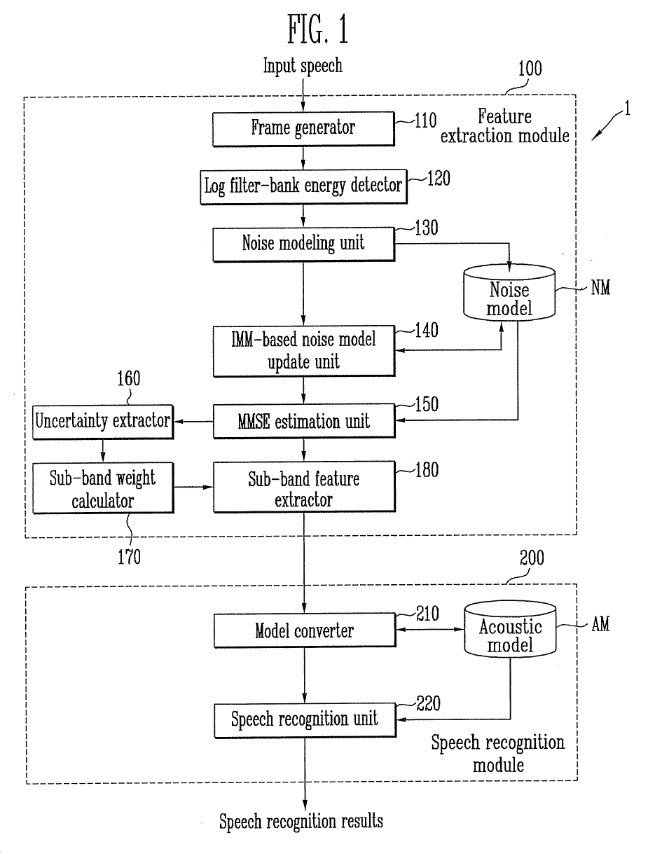

FIG. 1 is a block diagram illustrating the configuration of a speech recognition apparatus according to an exemplary embodiment of the present invention.

Referring to FIG. 1, the speech recognition apparatus 1 includes a feature extraction module 100 for extracting speech features from input noisy speech and a speech recognition module 200 for performing speech recognition based on the extracted speech features.

The feature extraction module 100 includes a frame generator 110, a log filter-bank energy detector 120, a noise modeling unit 130, an Interactive Multiple Model (IMM)-based noise model update unit 140, a Minimum Mean Squared Error (MMSE) estimation unit 150, an uncertainty extractor 160, a sub-band weight calculator 170, and a sub-band feature extractor 180, and operations of each unit will be described in detail below.

The frame generator 110 divides an input noisy speech signal by a length of 20 ms to 30 ms per 10 ms (approx.) to generate speech frames.

The log filter-bank energy detector 120 performs Fourier transform on each speech frame, detects N filter-bank energies for each interval, and applies a logarithm function to the detected filter-bank energies to detect log filter-bank energies.

The log filter-bank energy may be represented by the following Equation 1:

y=x+log(1+e^{n-x})=Ax+Bn+C [Equation 1]

wherein x, y and n denote the log filter-bank energy obtained from the log spectrum of original speech, noisy speech and noise, respectively, and A, B and C denote coefficients for linearization.

When the log filter-bank energy is output from the log filter-bank energy detector 120, the noise modeling unit 130 calculates the linear coefficients A, B and C by Equation 1 using mean and variance values of a log filter-bank energy during a silent interval to generate a noise model (NM).

The IMM-based noise model update unit 140 estimates the mean and variance values of the log filter-bank energy for each time frame using an IMM to update the NM.

Here, the IMM is a method, in which a noise spectrum of previous frame is applied to speech Gaussian mixture models, new noise spectrum is estimated using Kalman tracking for each mixture, and final noise spectrum for current frame is obtained from mixing new noise spectrum of each mixture, so that noise characteristics that vary over time are can be updated. Since the method is apparent to one of ordinary skill in the art, a detailed description thereof will be omitted.

The MMSE estimation unit 150 estimates clean speech by an MMSE method using the updated NM to extract a log filter-bank energy of the estimated clean speech. The log filter-bank energy of the estimated clean speech output from the MMSE estimation unit 150 may be represented by the following Equation 2:

$$x = E ( x \vert y ) = y - {\sum }_{m = 1}^{M} P ( m \vert y ) f ( {A}_{m} , {B}_{m} , n , {C}_{m} ) \qquad [ Equation 2 ]$$

wherein x, y and n denote the log filter-bank energy obtained from the log spectrum of original speech, noisy speech and noise, respectively, M denotes the number of mixtures in a Gaussian Mixture Model (GMM) as a speech model, and f(Aₘ, Bₘ, Cₘ) denotes a function with respect to a linear coefficient and noise component obtained at an initial utterance for each mixture by Equation 1.

The above process is performed in a band of a filter-bank energy, and the process may be performed in N bands when N filter-banks are used. Also, the process is performed for each time frame, and thus accurate noise modeling over time yields accurate estimation of the original speech.

However, as described above, while the IMM-based noise modeling method has excellent performance during a silent interval where noise only is present, modeling of the noise component is relatively less effectively performed due to an influence of speech during an interval in which speech and noise are mixed, so that noise still remains in the estimated clean speech after the noise is compensated for. Also, when the noise characteristics are instantaneously changed during a speech utterance interval, it is difficult to update the change in real-time, so that estimated clean speech close to the original speech may not be easily obtained.

In view of this drawback, uncertainty information of estimated clean speech for each sub-band is extracted from estimated clean speech obtained by noisy signal modeling, and the extracted results are used as a weight with respect to each sub-band to extract speech features that are robust to noise. Further descriptions will be made in detail below.

Referring again to FIG. 1, the uncertainty extractor 160 calculates a value of E(x²|y) using the same method as used in the calculation of estimated clean speech in Equation 2 and obtains a value corresponding to the variance of estimated clean speech to use the obtained value as the uncertainty information. That is, the degree of the uncertainty is determined depending on how many variableness the estimated clean speech has with respect to the corresponding noise model, and the uncertainty information U for each log filter-bank energy band is extracted by the following Equation 3:

$$\begin{matrix}U = E ( {x}^{2} \vert y ) - {[ E ( x \vert y ) ]}^{2} \\ E ( {x}^{2} \vert y ) = {y}^{2} - {\sum }_{m = 1}^{M} P ( m \vert y ) yf ( {A}_{m} , {B}_{m} , n , {C}_{m} ) + \\ {\sum }_{m = 1}^{M} P ( m \vert y ) {f}^{2} ( {A}_{m} , {B}_{m} , n , {C}_{m} ) \\ E ( x \vert y ) = y - {\sum }_{m = 1}^{M} P ( m \vert y ) f ( {A}_{m} , {B}_{m} , n , {C}_{m} )\end{matrix} \qquad [ Equation 3 ]$$

wherein x, y and n denote the log filter-bank energy obtained from the log spectrum of original speech, noisy speech and noise, respectively, f(Aₘ, Bₘ, Cₘ) denotes a function with respect to a linear coefficient and noise component obtained for each mixture and M denotes the number of mixtures in the GMM speech model.

When the uncertainty information U for each log filter-bank energy band is extracted by the above Equation 3, the sub-band weight calculator 170 calculates a weight nwₛ for each sub-band by applying the extracted uncertainty information U to the following Equation 4:

$${nw}_{s} = \frac{{w}_{s}}{{\sum }_{j = 1}^{S} wj} , where {w}_{s} = \frac{1}{{\sum }_{k = bs}^{es} {U}_{k}} \qquad [ Equation 4 ]$$

wherein nwₛ denotes a final weight of the s^{th} sub-band, and bs and es respectively denote the start and end point of a log filter-bank energy included in the s^{th} sub-band.

When the weight nwₛ for each sub-band is calculated by the above Equation 4, the sub-band feature extractor 180 extracts a final sub-band Mel-Frequency Cepstrum Coefficient (MFCC) of speech features based on MFCC of each sub-band. It can be more robust than the conventional MFCC by reducing the contribution of sub-bands having high uncertainty according to the weight nwₛ for each sub-band in the following Equation 5:

$$\begin{matrix}S B M F C C = {\sum }_{s = 1}^{S} M F C {C}_{x} , \\ where M F C {C}_{s} = D C T ( {nw}_{s} {E}_{k} \vert bs \leq k \leq es )\end{matrix} \qquad [ Equation 5 ]$$

wherein MFCCₛ denotes sub-band MFCC obtained by DCT(Discrete Cosine Transform) of multiplying a log filter-bank energy Eₖ included in a sub-band s and the sub-band weight obtained by the above Equation 4, and SBMFCC denotes final sub-band MFCC obtained by summing the sub-band MFCC obtained for each sub-band.

When the weight for each sub-band is accurate, it can be confirmed from Equation 5 that the sub-band MFCC do not spread the noise influence of specific sub-band over other sub-bands, so that the final sub-band MFCC can be robust to noise.

When the final sub-band MFCC with respect to a speech signal and the sub-band weight applied thereto are output from the feature extraction module 100, the speech recognition module 200 converts an acoustic model (AM) according to the sub-band weight and performs speech recognition based on the converted AM. This is described in more detail below.

First, a model converter 210 converts a Gaussian average value of the AM consisting of a lot of Gaussian models into the log filter-bank domain and converts the AM using the sub-band weight applied to the final sub-band MFCC. Then AM is transformed into cepstrum domain using discrete cosine transform.

That is, an acoustic model used for speech recognition is generally trained using a clear speech database in a noise-free condition, and thus when noise is added to input noisy speech, a mismatch between extracted features and the acoustic model is generated to deteriorate speech recognition performance. To compensate for the mismatch, an acoustic model is adapted according to a sub-band weight, and this provides the compromise between an acoustic model and the current noisy condition.

According to the above process, when the AM is converted according to the sub-band weight, a speech recognition unit 220 performs speech recognition based on the converted AM and the final sub-band MFCC to output speech recognition results.

In other words, the uncertainty information for each sub-band is extracted from the estimated clean speech obtained by noise modeling, and the extracted results are used as a weight of each sub-band to extract speech features that are robust to noise. In addition, the acoustic model is converted according to each sub-band weight, and speech recognition is performed based on the converted acoustic model and the extracted speech features, so that while the noise modeling over time is not so accurate, noise influence resulted from sub-bands having high corruption are reduced using the uncertainty information of the corresponding sub-bands, and then speech recognition performance can be improved.

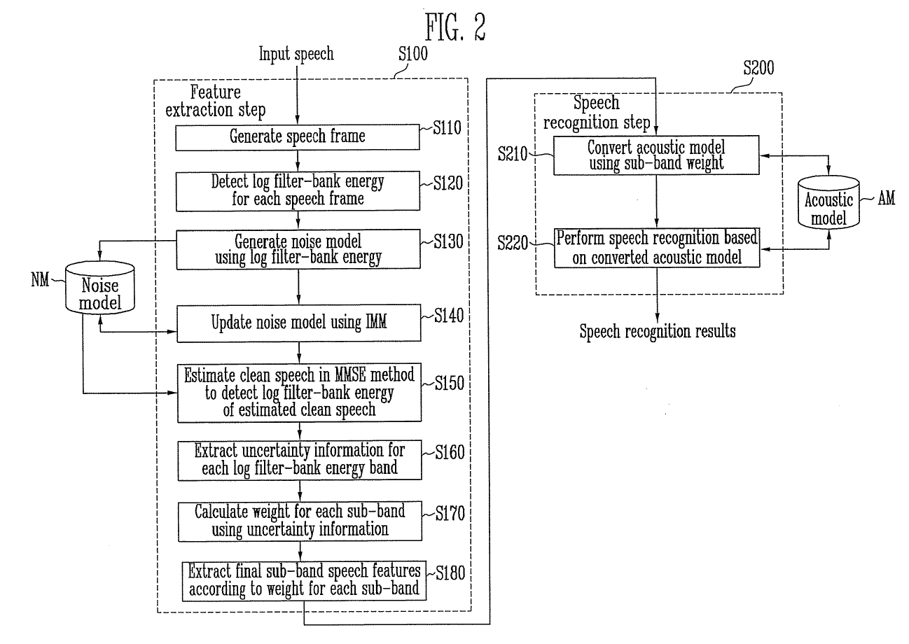

FIG. 2 is a flowchart illustrating a method for speech recognition according to an exemplary embodiment of the present invention.

Referring to FIG. 2, the method for speech recognition according to the present invention includes step S100 of extracting speech features from input noisy speech and step S200 of performing speech recognition based on the speech features extracted in step S100.

The features extracting step (S100) will be further described below.

In sub-step S110, when a speech signal is input, the input signal is divided into a length of 20 ms to 30 ms per 10 ms (approx.) to generate speech frames.

In sub-step S120, Fourier transform is performed on each speech frame, N filter-bank energies for each interval are computed, and a logarithm function is applied to the computed filter-bank energies to obtain log filter-bank energies.

In sub-step S130, mean and variance values of a log filter-bank energy during a silent interval are used to generate an NM S130, and in sub-step S140, the mean and variance values of the log filter-bank energies are estimated for each time frame, to update the NM using an IMM method.

Subsequently, in sub-step S150, clean speech of current frame is estimated from an MMSE method using the updated NM.

Afterwards, in sub-step S160, a variance of the log filter-bank energy of the estimated clean speech according to the MMSE is calculated to extract uncertainty information U for each log filter-bank energy band by the above Equation 3.

In sub-step S170, a weight for each sub-band is calculated using the extracted uncertainty information U for each log filter-bank energy band. In sub-step S180, after performing sub-step 170, the final sub-band MFCC is extracted using the sub-band MFCC obtained by the above Equation 5.

When the final sub-band MFCC with respect to the input noisy speech signal and the sub-band weight value applied thereto are extracted through the above process, the speech recognition step (S200) is performed using them. The speech recognition step (S200) will be further described below.

In sub-step S210, the mean value of Gaussian distributions of an AM consisting of a lot of Gaussian models is converted into the log filter-bank domain, and the AM is converted using the sub-band weight applied to the final sub-band MFCC. Then the AM is returned to cepstrum domain.

Then, in sub-step S220, speech recognition is performed based on the AM converted according to the sub-band weight to output speech recognition results.

As described above, according to the present invention, the uncertainty information of each sub-band is extracted from estimated clean speech using noise modeling, and helps to extract speech features that are robust to noise using the extracted results as a weight with respect to each sub-band. Also, an acoustic model is converted according to each sub-band weight, and speech recognition is performed based on the converted acoustic model and the extracted speech features. As a result, while the noise modeling over time is not so accurate, noise influence resulted from sub-bands having high corruption can be reduced according to the uncertainty information of the corresponding sub-band, and speech recognition performance in complex noise environments can be improved.

Exemplary embodiments of the invention are shown in the drawings and described above in specific terms. However, no part of the above disclosure is intended to limit the scope of the overall invention. It will be understood by those of ordinary skill in the art that various changes in form and details may be made to the exemplary embodiments without departing from the spirit and scope of the present invention as defined by the following claims.

1. A method for speech recognition in noise environment using uncertainty information for sub-bands, comprising:
estimating clean speech, in which noise is removed, from an input noisy speech signal, extracting uncertainty information of each sub-band from the estimated clean speech, and extracting speech features using the extracted uncertainty information as a sub-band weight; and
converting an acoustic model according to the sub-band weight to perform speech recognition based on the converted acoustic model and the extracted speech features.

2. The method of claim 1, wherein the extracting speech features comprises:
obtaining the log filter-bank energies with respect to each speech frame of the input noisy speech signal;
updating a noise model using the log filter-bank energies with respect to each speech frame based on an Interactive Multiple Model (IMM);
estimating clean speech, in which noise is removed, in a Minimum Mean Squared Error (MMSE) method using the updated noise model and extracting uncertainty information for each sub-band using the log filter-bank energies of the estimated clean speech; and
calculating a weight of each sub-band using the uncertainty information for each sub-band and extracting final sub-band speech features using the weight for each sub-band.

3. The method of claim 2, wherein the log filter-bank energies y with respect to each speech frame is represented by the following equation:
y=x+log(1+e^{n-x})=Ax+Bn+C
wherein x, y and n denote the log filter-bank energies obtained from the log spectrum of original speech, noisy speech and noise, respectively, and A, B and C denote linearization coefficients.

4. The method of claim 2, wherein the log filter-bank energies x of the estimated clean speech the extracting uncertainty information for each sub-band using the log filter-bank energies of the estimated clean speech is represented by the following equation:
$$x = E ( x \vert y ) = y - {\sum }_{m = 1}^{M} P ( m \vert y ) f ( {A}_{m} , {B}_{m} , n , {C}_{m} )$$
wherein x, y and n denote the log filter-bank energies obtained from the log spectrum of original speech, noisy speech and noise, respectively, M denotes the number of mixtures used in a speech model, a Gaussian Mixture Model (GMM), and f(Aₘ, Bₘ, Cₘ) denotes a function with respect to linearization coefficients and noise component obtained for each mixture.

5. The method of claim 2, wherein the uncertainty information U for each sub-band the extracting uncertainty information for each sub-band using the log filter-bank energies of the estimated clean speech is extracted by the following equation:
$$\begin{matrix}U = E ( {x}^{2} \vert y ) - {[ E ( x \vert y ) ]}^{2} \\ E ( {x}^{2} \vert y ) = {y}^{2} - {\sum }_{m = 1}^{M} P ( m \vert y ) yf ( {A}_{m} , {B}_{m} , n , {C}_{m} ) + \\ {\sum }_{m = 1}^{M} P ( m \vert y ) {f}^{2} ( {A}_{m} , {B}_{m} , n , {C}_{m} ) \\ E ( x \vert y ) = y - {\sum }_{m = 1}^{M} P ( m \vert y ) f ( {A}_{m} , {B}_{m} , n , {C}_{m} )\end{matrix}$$
wherein x, y and n denote the log filter-bank energies obtained from the log spectrum of original speech, noisy speech and noise, respectively, M denotes the number of mixtures used in a speech model, a GMM, and f(Aₘ, Bₘ, Cₘ) denotes a function with respect to linearization coefficients and noise component obtained for each mixture.

6. The method of claim 2, wherein the weight nwₛ for each sub-band the calculating a weight for each sub-band using the extracted uncertainty information for each sub-band is calculated by the following equation:
$${nw}_{s} = \frac{{w}_{s}}{{\sum }_{j = 1}^{S} wj} , where {w}_{s} = \frac{1}{{\sum }_{k = bs}^{es} {U}_{k}}$$
wherein nwₛ denotes a final weight of the s^{th} sub-band, and bs and es respectively denote the start and end of log filter-bank energies included in the s^{th} sub-band.

7. The method of claim 2, wherein the final sub-band speech features SBMFCC the extracting final sub-band speech features using the weight for each sub-band are extracted by the following equation:
$$S B M F C C = {\sum }_{s = 1}^{S} M F C {C}_{x} , where$$
$$M F C {C}_{s} = D C T ( {nw}_{s} {E}_{k} \vert bs \leq k \leq es )$$
wherein MFCCₛ denotes sub-band MFCC obtained by DCT(Discrete Cosine Transform) of multiplying log filter-bank energies Eₖ included in a sub-band s and the sub-band weight nwₛ, and SBMFCC denotes the final sub-band MFCC obtained by summing the sub-band MFCC obtained for each sub-band.

8. The method of claim 1, wherein the performing speech recognition comprises:
converting the mean value of Gaussian distribution of the acoustic model into the log filter-bank domain and converting the acoustic model using the sub-band weight; and
performing speech recognition based on the converted acoustic model and the extracted speech features.

9. An apparatus for speech recognition in noise environments using uncertainty information for sub-bands, comprising:
a feature extraction module to estimate clean speech from an input noisy speech signal to extract uncertainty information of each sub-band from the estimated clean speech and using the extracted uncertainty information as a sub-band weight to extract speech features; and
a speech recognition module to convert an acoustic model according to the sub-band weight and to perform speech recognition based on the converted acoustic model and the extracted speech features.

10. The apparatus of claim 9, wherein the feature extraction module comprises:
a frame generator to divide the input noisy speech signal to generate speech frames;
a log filter-bank energy detector to detect log filter-bank energies with respect to each of the speech frames;
a noise modeling unit to generate a noise model using the log filter-bank energies with respect to each of the speech frames;
an IMM-based noise model update unit to update the noise model based on an IMM;
an MMSE estimation unit to estimate clean speech in an MMSE method using the updated noise model;
an uncertainty extractor to extract uncertainty information for each sub-band using the log filter-bank energies of the estimated clean speech;
a sub-band weight calculator to calculate a weight for each sub-band using the uncertainty information for each sub-band; and
a sub-band feature extractor to extract final sub-band speech features using the weight for each sub-band.

11. The apparatus of claim 9, wherein the speech recognition module comprises:
a model converter to convert the mean value of Gaussian distribution of the acoustic model into the log filter-bank domain, to convert the acoustic model using the sub-band weight, and to return the converted acoustic model to cepstrum domain; and
a speech recognition unit to perform speech recognition using the converted acoustic model and the extracted speech features.
